(19) United States
(12) Patent Application Publication
(10) Pub. No.: US 2026/0296537 A1
(43) Pub. Date: Oct. 1, 2026

(54) SYSTEMS AND METHODS FOR A FRICTION ESTIMATION METHOD FOR A STEER-BY-WIRE ROADWHEEL ACTUATOR SYSTEM BASED ON CLOSED-LOOP ADJUSTMENT OF A HYSTERETIC GAIN COEFFICIENT

(71) Applicant: STEERING SOLUTIONS IP HOLDING CORPORATION, Saginaw, MI (US)

(72) Inventors: Zack ZUO, Suzhou (CN); Yongfei LIU, Suzhou (CN); Jovan LI, Suzhou (CN); Snowy ZHANG, Suzhou (CN)

(21) Appl. No.: 19/197,407

(22) Filed: May 2, 2025

(30) Foreign Application Priority Data
Mar. 26, 2025 (CN) 202510373288.5

(51) Int. Cl. B62D 6/00; B62D 5/04

(52) U.S. Cl. CPC B62D 6/008; B62D 5/0463

(57) ABSTRACT

A method for friction estimation includes receiving at least a rack position value associated with a rack of a steering system, and determining whether the rack position value is within a rack position range. The method also includes, in response to a determination that the rack position value is within the rack position range: determining a hysteresis force correction value based on a steering input signal; estimating a road friction value based on the hysteresis force correction value, and the rack position value; and selectively controlling at least one aspect of the steering system based on the estimated road friction value.

### CROSS REFERENCE TO RELATED APPLICATIONS

This U.S. Non-Provisional patent application claims the benefit of and priority to Chinese Patent Application Serial No. 202510373288.5, filed Mar. 26, 2025, the contents of which are incorporated herein by reference in its entirety.

### TECHNICAL FIELD

This disclosure relates to steering systems, and in particular, to systems and methods for a steer-by-wire roadwheel actuator system that uses closed-loop adjustments of a hysteretic gain coefficient.

### BACKGROUND

A vehicle, such as a car, truck, sport utility vehicle, crossover, mini-van, marine craft, aircraft, all-terrain vehicle, recreational vehicle, or other suitable forms of transportation, typically includes various systems, such as a steering system, which may include an electronic power steering (EPS) system, a steer-by-wire (SbW) steering system, a hydraulic steering system, or other suitable steering system and/or other suitable systems (e.g., such as a braking system, propulsion system, and the like). Such systems of the vehicle typically controls various aspects of vehicle steering (e.g., including providing steering assist to an operator of the vehicle, controlling steerable wheels of the vehicle, and the like), vehicle propulsion, vehicle braking, and the like.

### SUMMARY

This disclosure relates generally to steering systems.

An aspect of the disclosed embodiments includes a system for friction estimation. The system includes a processor, and a memory. The memory includes instructions that, when executed by the processor, cause the processor to: receive at least a rack position value associated with a rack of a steering system; determine whether the rack position value is within a rack position range; and in response to a determination that the rack position value is within the rack position range: determine a hysteresis force correction value based on a steering input signal; estimate a road friction value based on the hysteresis force correction value, and the rack position value; and selectively control at least one aspect of the steering system based on the estimated road friction value.

Another aspect of the disclosed embodiments includes a method for friction estimation. The method includes receiving at least a rack position value associated with a rack of a steering system, and determining whether the rack position value is within a rack position range. The method also includes, in response to a determination that the rack position value is within the rack position range: determining a hysteresis force correction value based on a steering input signal; estimating a road friction value based on the hysteresis force correction value, and the rack position value; and selectively controlling at least one aspect of the steering system based on the estimated road friction value.

Another aspect of the disclosed embodiments includes an apparatus for friction estimation. The apparatus includes a controller configured to: receive at least a rack position value associated with a rack of a steering system; receive a rack velocity value associated with the rack of the steering system; receive a vehicle velocity value; and, in response to a determination that (i) the rack position value is within a rack position range, (ii) the rack velocity value is within a rack velocity range, and (iii) the vehicle velocity value is within a vehicle velocity range: determine a hysteresis force correction value based on a steering input signal; estimate a road friction value based on the hysteresis force correction value, the rack position value, the rack velocity value, and the vehicle velocity value; and selectively control at least one aspect of the steering system based on the estimated road friction value.

These and other aspects of the present disclosure are disclosed in the following detailed description of the embodiments, the appended claims, and the accompanying figures.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 generally illustrates a vehicle according to the principles of the present disclosure.

FIG. 2 generally illustrates a controller according to the principles of the present disclosure.

FIGS. 3A-3B generally illustrate block diagrams of a friction estimation system according to the principles of the present disclosure.

FIG. 4 is a flow diagram generally illustrating a friction estimation method according to the principles of the present disclosure.

### DETAILED DESCRIPTION

The following discussion is directed to various embodiments of the disclosure. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

As described, a vehicle, such as a car, truck, sport utility vehicle, crossover, mini-van, marine craft, aircraft, all-terrain vehicle, recreational vehicle, or other suitable forms of transportation, typically includes various systems, such as a steering system, which may include an EPS system, an SbW steering system, a hydraulic steering system, or other suitable steering system and/or other suitable systems (e.g., such as a braking system, propulsion system, and the like). Such systems of the vehicle typically controls various aspects of vehicle steering (e.g., including providing steering assist to an operator of the vehicle, controlling steerable wheels of the vehicle, and the like), vehicle propulsion, vehicle braking, and the like.

Typical SbW steering systems include one or more roadwheel actuators (RWA). Such RWAs may experience mechanical system issues which m ay affect performance or lead to functional degradation. As such, internal system friction is typically monitored and compensated. For example, a friction calculation method may use handwheel torque, motor torque, and/or handwheel angle to estimate steering system friction, which results in relatively slow hysteresis force tuning. In addition, system learning may be time consuming.

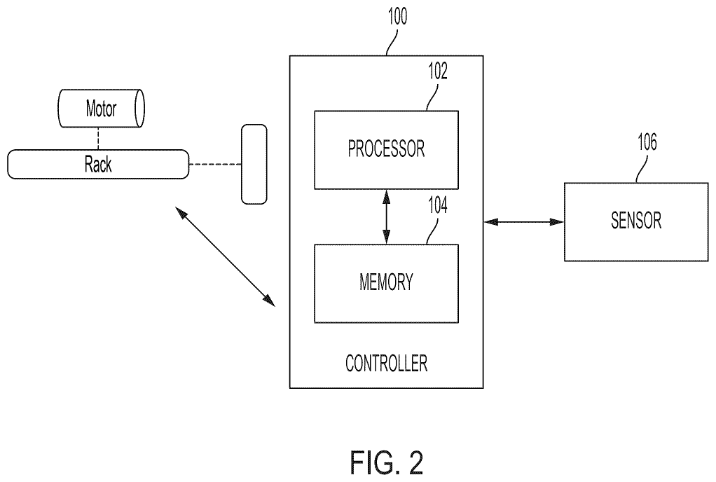

Accordingly, systems and methods, such as those described herein, configured to provide improved friction estimation, may be desirable. In some embodiments the systems and methods described herein may be configured to use rack position, rack velocity, and/or RWA motor torque (e.g., associated with a RWA and/or motor, as is generally illustrated in FIG. 2) to periodically tune the hysteretic force and auto-adjust a correction coefficient to estimated system friction.

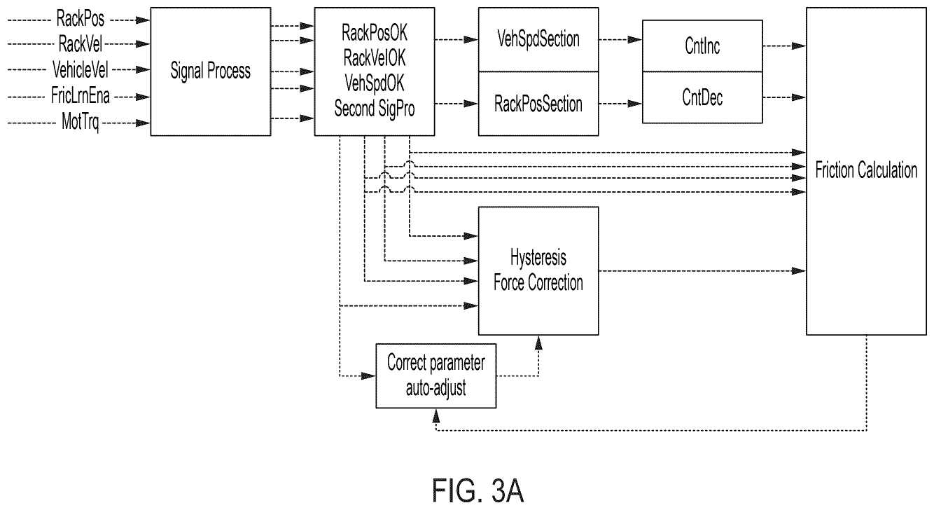

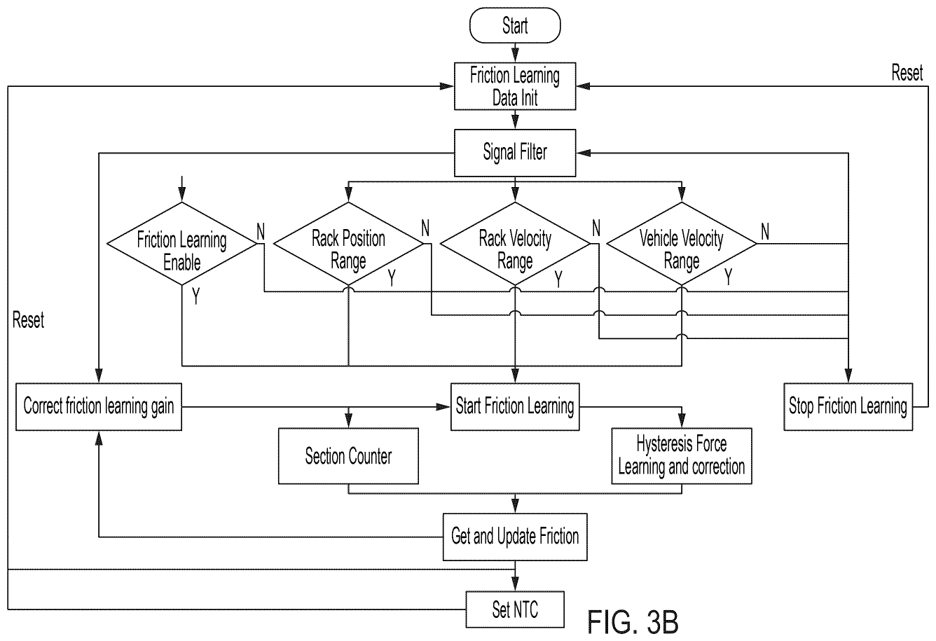

As is generally illustrated in FIGS. 3A and 3B, the systems and methods described herein may be configured to provide signal processing to process and/or filter signals, avoiding signal oscillation. The systems and methods described herein may be configured to provide a learning section that provides a judgement based on rack position, vehicle speed, and/or rack velocity, to achieve proper entry conditions of friction learning.

The systems and methods described herein may be configured to provide hysteresis force correction based on actual steering system input signals to modify a precise hysteresis force. The systems and methods described herein may be configured to auto-correct a parameter gain based on input torque and real time friction learning results, auto-adjust correct gain. The systems and methods described herein may be configured to provide friction learning using mean iteration to calculate system friction.

In some embodiments, the systems and methods described herein may be configured to provide an improved friction learning method in Sbw-RWA systems. The systems and methods described herein may be configured to use a closed-loop to auto-adjust a friction learning correction coefficient, and to reduce friction learning cycle time.

In some embodiments, the systems and methods described herein may be configured to receive at least a rack position value associated with a rack of a steering system. The systems and methods described herein may be configured to determine whether the rack position value is within a rack position range.

The systems and methods described herein may be configured to, in response to a determination that the rack position value is within the rack position range: determine a hysteresis force correction value based on a steering input signal; estimate a road friction value based on the hysteresis force correction value, and the rack position value; and selectively control at least one aspect of the steering system based on the estimated road friction value.

The systems and methods described herein may be configured to determine a corrected gain parameter based on an input torque value and the estimated road friction value. The systems and methods described herein may be configured to adjust the hysteresis force correction value based on the corrected gain parameter. The systems and methods described herein may be configured to update the estimated road friction value based on the adjusted hysteresis force correction value.

In some embodiments, the systems and methods described herein may be configured to receive a rack velocity value associated with the rack of the steering system. The systems and methods described herein may be configured to determine whether the rack velocity value is within a rack velocity range. The systems and methods described herein may be configured to, in response to a determination that the rack velocity value is within the rack velocity range, estimate the road friction value further based on the rack velocity value.

In some embodiments, the systems and methods described herein may be configured to receive a vehicle velocity value. The systems and methods described herein may be configured to determine whether the vehicle velocity value is within a vehicle velocity range. The systems and methods described herein may be configured to, in response to a determination that the vehicle velocity value is within the vehicle velocity range, estimate the road friction value further based on the vehicle velocity value.

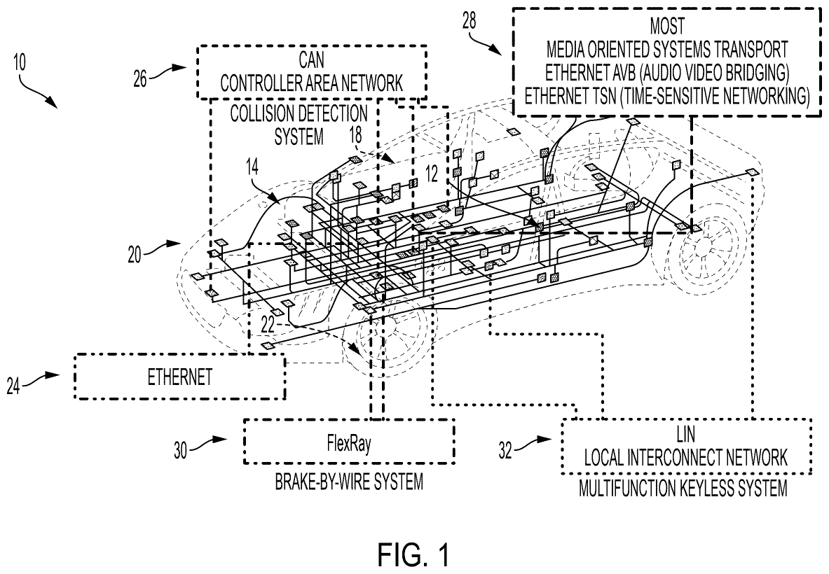

FIG. 1 generally illustrates a vehicle 10 according to the principles of the present disclosure. The vehicle 10 may include any suitable vehicle, such as a car, a truck, a sport utility vehicle, a mini-van, a crossover, any other passenger vehicle, any suitable commercial vehicle, or any other suitable vehicle. While the vehicle 10 is illustrated as a passenger vehicle having wheels and for use on roads, the principles of the present disclosure may apply to other vehicles, such as planes, boats, trains, drones, or other suitable vehicles.

The vehicle 10 includes a vehicle body 12 and a hood 14. A passenger compartment 18 is at least partially defined by the vehicle body 12. Another portion of the vehicle body 12 defines an engine compartment 20. The hood 14 may be moveably attached to a portion of the vehicle body 12, such that the hood 14 provides access to the engine compartment 20 when the hood 14 is in a first or open position and the hood 14 covers the engine compartment 20 when the hood 14 is in a second or closed position. In some embodiments, the engine compartment 20 may be disposed on rearward portion of the vehicle 10 than is generally illustrated.

The passenger compartment 18 may be disposed rearward of the engine compartment 20, but may be disposed forward of the engine compartment 20 in embodiments where the engine compartment 20 is disposed on the rearward portion of the vehicle 10. The vehicle 10 may include any suitable propulsion system including an internal combustion engine, one or more electric motors (e.g., an electric vehicle), one or more fuel cells, a hybrid (e.g., a hybrid vehicle) propulsion system comprising a combination of an internal combustion engine, one or more electric motors, and/or any other suitable propulsion system.

In some embodiments, the vehicle 10 may include a petrol or gasoline fuel engine, such as a spark ignition engine. In some embodiments, the vehicle 10 may include a diesel fuel engine, such as a compression ignition engine. The engine compartment 20 houses and/or encloses at least some components of the propulsion system of the vehicle 10. Additionally, or alternatively, propulsion controls, such as an accelerator actuator (e.g., an accelerator pedal), a brake actuator (e.g., a brake pedal), a handwheel, and other such components are disposed in the passenger compartment 18 of the vehicle 10. The propulsion controls may be actuated or controlled by an operator of the vehicle 10 and may be directly connected to corresponding components of the propulsion system, such as a throttle, a brake, a vehicle axle, a vehicle transmission, and the like, respectively. In some embodiments, the propulsion controls may communicate signals to a vehicle computer (e.g., drive by wire) which in turn may control the corresponding propulsion component of the propulsion system. As such, in some embodiments, the vehicle 10 may be an autonomous vehicle.

In some embodiments, the vehicle 10 includes a transmission in communication with a crankshaft via a flywheel or clutch or fluid coupling. In some embodiments, the transmission includes a manual transmission. In some embodiments, the transmission includes an automatic transmission. The vehicle 10 may include one or more pistons, in the case of an internal combustion engine or a hybrid vehicle, which cooperatively operate with the crankshaft to generate force, which is translated through the transmission to one or more axles, which turns wheels 22. When the vehicle 10 includes one or more electric motors, a vehicle battery, and/or fuel cell provides energy to the electric motors to turn the wheels 22.

The vehicle 10 may include automatic vehicle propulsion systems, such as a cruise control, an adaptive cruise control, automatic braking control, other automatic vehicle propulsion systems, or a combination thereof. The vehicle 10 may be an autonomous or semi-autonomous vehicle, or other suitable type of vehicle. The vehicle 10 may include additional or fewer features than those generally illustrated and/or disclosed herein.

In some embodiments, the vehicle 10 may include an Ethernet component 24, a controller area network (CAN) bus 26, a media oriented systems transport component (MOST) 28, a FlexRay component 30 (e.g., brake-by-wire system, and the like), and a local interconnect network component (LIN) 32. The vehicle 10 may use the CAN bus 26, the MOST 28, the FlexRay Component 30, the LIN 32, other suitable networks or communication systems, or a combination thereof to communicate various information from, for example, sensors within or external to the vehicle, to, for example, various processors or controllers within or external to the vehicle. The vehicle 10 may include additional or fewer features than those generally illustrated and/or disclosed herein.

In some embodiments, the vehicle 10 may include a steering system, such as an EPS system, a steering-by-wire steering system (e.g., which may include or communicate with one or more controllers that control components of the steering system without the use of mechanical connection between the handwheel and wheels 22 of the vehicle 10), a hydraulic steering system (e.g., which may include a magnetic actuator incorporated into a valve assembly of the hydraulic steering system), or other suitable steering system.

The steering system may include an open-loop feedback control system or mechanism, a closed-loop feedback control system or mechanism, or combination thereof. The steering system may be configured to receive various inputs, including, but not limited to, a handwheel position, an input torque, one or more roadwheel positions, other suitable inputs or information, or a combination thereof.

Additionally, or alternatively, the inputs may include a handwheel torque, a handwheel angle, a motor velocity, a vehicle speed, an estimated motor torque command, other suitable input, or a combination thereof. The steering system may be configured to provide steering function and/or control to the vehicle 10. For example, the steering system may generate an assist torque based on the various inputs. The steering system may be configured to selectively control a motor of the steering system using the assist torque to provide steering assist to the operator of the vehicle 10.

In some embodiments, the vehicle 10 may include a controller, such as controller 100, as is generally illustrated in FIG. 2. The controller 100 may include any suitable controller, such as an electronic control unit or other suitable controller. The controller 100 may be configured to control, for example, the various functions of the steering system and/or various functions of the vehicle 10. The controller 100 may include a processor 102 and a memory 104. The processor 102 may include any suitable processor, such as those described herein. Additionally, or alternatively, the controller 100 may include any suitable number of processors, in addition to or other than the processor 102. The memory 104 may comprise a single disk or a plurality of disks (e.g., hard drives), and includes a storage management module that manages one or more partitions within the memory 104. In some embodiments, memory 104 may include flash memory, semiconductor (solid state) memory or the like. The memory 104 may include Random Access Memory (RAM), a Read-Only Memory (ROM), or a combination thereof. The memory 104 may include instructions that, when executed by the processor 102, cause the processor 102 to, at least, control various aspects of the vehicle 10.

The controller 100 may receive one or more signals from various measurement devices or sensors 106 indicating sensed or measured characteristics of the vehicle 10. The sensors 106 may include any suitable sensors, measurement devices, and/or other suitable mechanisms. For example, the sensors 106 may include one or more torque sensors or devices, one or more handwheel position sensors or devices, one or more motor position sensor or devices, one or more position sensors or devices, one or more radar sensors or devices, one or more lidar sensors or devices, one or more sonar sensors or devices, one or more image capturing sensors or devices, other suitable sensors or devices, or a combination thereof. The one or more signals may indicate a handwheel torque, a handwheel angle, a motor velocity, a vehicle speed, other suitable information, or a combination thereof.

In some embodiments, the controller 100 may be configured to provide friction estimation. For example, the controller 100 may receive at least a rack position value associated with a rack of a steering system. The controller 100 may determine whether the rack position value is within a rack position range.

The controller 100 may, in response to a determination that the rack position value is within the rack position range, determine a hysteresis force correction value based on a steering input signal. The controller 100 may estimate a road friction value based on the hysteresis force correction value, and the rack position value. The controller 100 may selectively control at least one aspect of the steering system based on the estimated road friction value.

The controller 100 may determine a corrected gain parameter based on an input torque value and the estimated road friction value. The controller 100 may adjust the hysteresis force correction value based on the corrected gain parameter. The controller 100 may update the estimated road friction value based on the adjusted hysteresis force correction value.

In some embodiments, the controller 100 may receive a rack velocity value associated with the rack of the steering system. The controller 100 may determine whether the rack velocity value is within a rack velocity range. The controller 100 may, in response to a determination that the rack velocity value is within the rack velocity range, estimate the road friction value further based on the rack velocity value.

In some embodiments, the controller 100 may receive a vehicle velocity value. The controller 100 may determine whether the vehicle velocity value is within a vehicle velocity range. The s controller 100 may, in response to a determination that the vehicle velocity value is within the vehicle velocity range, estimate the road friction value further based on the vehicle velocity value.

In some embodiments, the controller 100 may receive at least a rack position value associated with a rack of a steering system. The controller 100 may receive a rack velocity value associated with the rack of the steering system. The controller 100 may receive a vehicle velocity value.

The controller 100 may, in response to a determination that (i) the rack position value is within a rack position range, (ii) the rack velocity value is within a rack velocity range, and (iii) the vehicle velocity value is within a vehicle velocity range, determine a hysteresis force correction value based on a steering input signal. The controller 100 may estimate a road friction value based on the hysteresis force correction value, the rack position value, the rack velocity value, and the vehicle velocity value. The controller 100 may selectively control at least one aspect of the steering system based on the estimated road friction value.

In some embodiments, the controller 100 may perform the methods described herein. However, the methods described herein as performed by the controller 100 are not meant to be limiting, and any type of software executed on a controller or processor can perform the methods described herein without departing from the scope of this disclosure. For example, a controller, such as a processor executing software within a computing device, can perform the methods described herein.

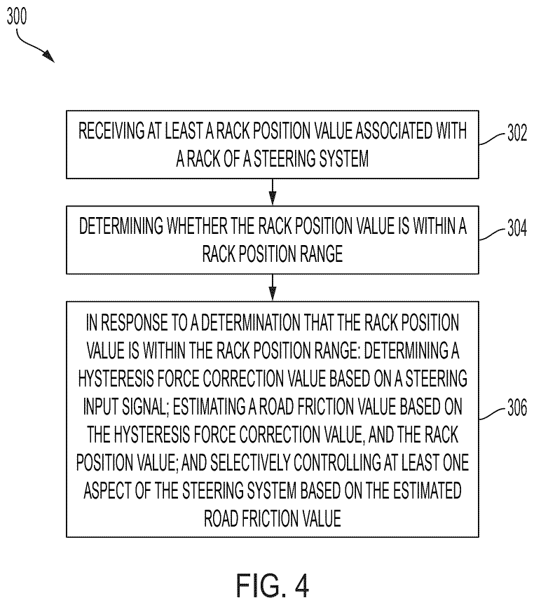

FIG. 4 is a flow diagram generally illustrated a friction estimation method 300 according to the principles of the present disclosure. At 302, the method 300 receives at least a rack position value associated with a rack of a steering system.

At 304, the method 300 determines whether the rack position value is within a rack position range.

At 306, the method 300, in response to a determination that the rack position value is within the rack position range: determines a hysteresis force correction value based on a steering input signal; estimates a road friction value based on the hysteresis force correction value, and the rack position value; and selectively controls at least one aspect of the steering system based on the estimated road friction value.

In some embodiments, a system for friction estimation includes a processor, and a memory. The memory includes instructions that, when executed by the processor, cause the processor to: receive at least a rack position value associated with a rack of a steering system; determine whether the rack position value is within a rack position range; and in response to a determination that the rack position value is within the rack position range: determine a hysteresis force correction value based on a steering input signal; estimate a road friction value based on the hysteresis force correction value, and the rack position value; and selectively control at least one aspect of the steering system based on the estimated road friction value.

In some embodiments, the instructions further cause the processor to determine a corrected gain parameter based on an input torque value and the estimated road friction value. In some embodiments, the instructions further cause the process to adjust the hysteresis force correction value based on the corrected gain parameter. In some embodiments, the instructions further cause the processor to update the estimated road friction value based on the adjusted hysteresis force correction value. In some embodiments, the instructions further cause the processor to: receive a rack velocity value associated with the rack of the steering system; and determine whether the rack velocity value is within a rack velocity range. In some embodiments, the instructions further cause the processor to, in response to a determination that the rack velocity value is within the rack velocity range, estimate the road friction value further based on the rack velocity value. In some embodiments, the instructions further cause the processor to: receive a vehicle velocity value; and determine whether the vehicle velocity value is within a vehicle velocity range. In some embodiments, the instructions further cause the processor to, in response to a determination that the vehicle velocity value is within the vehicle velocity range, estimate the road friction value further based on the vehicle velocity value. In some embodiments, the steering system includes a steer-by-wire steering system. In some embodiments, the at least one aspect of the steering system includes a roadwheel actuator of the steering system.

In some embodiments, a method for friction estimation includes receiving at least a rack position value associated with a rack of a steering system, and determining whether the rack position value is within a rack position range. The method also includes, in response to a determination that the rack position value is within the rack position range: determining a hysteresis force correction value based on a steering input signal; estimating a road friction value based on the hysteresis force correction value, and the rack position value; and selectively controlling at least one aspect of the steering system based on the estimated road friction value.

In some embodiments, the method also includes determining a corrected gain parameter based on an input torque value and the estimated road friction value. In some embodiments, the method also includes adjusting the hysteresis force correction value based on the corrected gain parameter. In some embodiments, the method also includes updating the estimated road friction value based on the adjusted hysteresis force correction value. In some embodiments, the method also includes: receiving a rack velocity value associated with the rack of the steering system; and determining whether the rack velocity value is within a rack velocity range. In some embodiments, the method also includes, in response to a determination that the rack velocity value is within the rack velocity range, estimating the road friction value further based on the rack velocity value. In some embodiments, the method also includes: receiving a vehicle velocity value; and determining whether the vehicle velocity value is within a vehicle velocity range. In some embodiments, the method also includes, in response to a determination that the vehicle velocity value is within the vehicle velocity range, estimating the road friction value further based on the vehicle velocity value. In some embodiments, the at least one aspect of the steering system includes a roadwheel actuator of the steering system.

In some embodiments, an apparatus for friction estimation includes a controller configured to: receive at least a rack position value associated with a rack of a steering system; receive a rack velocity value associated with the rack of the steering system; receive a vehicle velocity value; and, in response to a determination that (i) the rack position value is within a rack position range, (ii) the rack velocity value is within a rack velocity range, and (iii) the vehicle velocity value is within a vehicle velocity range: determine a hysteresis force correction value based on a steering input signal; estimate a road friction value based on the hysteresis force correction value, the rack position value, the rack velocity value, and the vehicle velocity value; and selectively control at least one aspect of the steering system based on the estimated road friction value.

The above discussion is meant to be illustrative of the principles and various embodiments of the present disclosure. Numerous variations and modifications will become apparent to those skilled in the art once the above disclosure is fully appreciated. It is intended that the following claims be interpreted to embrace all such variations and modifications.

The word “example” is used herein to mean serving as an example, instance, or illustration. Any aspect or design described herein as “example” is not necessarily to be construed as preferred or advantageous over other aspects or designs. Rather, use of the word “example” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an implementation” or “one implementation” throughout is not intended to mean the same embodiment or implementation unless described as such.

Implementations the systems, algorithms, methods, instructions, etc., described herein can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors, or any other suitable circuit. In the claims, the term “processor” should be understood as encompassing any of the foregoing hardware, either singly or in combination. The terms “signal” and “data” are used interchangeably.

As used herein, the term module can include a packaged functional hardware unit designed for use with other components, a set of instructions executable by a controller (e.g., a processor executing software or firmware), processing circuitry configured to perform a particular function, and a self-contained hardware or software component that interfaces with a larger system. For example, a module can include an application specific integrated circuit (ASIC), a Field Programmable Gate Array (FPGA), a circuit, digital logic circuit, an analog circuit, a combination of discrete circuits, gates, and other types of hardware or combination thereof. In other embodiments, a module can include memory that stores instructions executable by a controller to implement a feature of the module.

Further, in one aspect, for example, systems described herein can be implemented using a general-purpose computer or general-purpose processor with a computer program that, when executed, carries out any of the respective methods, algorithms, and/or instructions described herein. In addition, or alternatively, for example, a special purpose computer/processor can be utilized which can contain other hardware for carrying out any of the methods, algorithms, or instructions described herein.

Further, all or a portion of implementations of the present disclosure can take the form of a computer program product accessible from, for example, a computer-usable or computer-readable medium. A computer-usable or computer-readable medium can be any device that can, for example, tangibly contain, store, communicate, or transport the program for use by or in connection with any processor. The medium can be, for example, an electronic, magnetic, optical, electromagnetic, or a semiconductor device. Other suitable mediums are also available.

The above-described embodiments, implementations, and aspects have been described in order to allow easy understanding of the present disclosure and do not limit the present disclosure. On the contrary, the disclosure is intended to cover various modifications and equivalent arrangements included within the scope of the appended claims, which scope is to be accorded the broadest interpretation so as to encompass all such modifications and equivalent structure as is permitted under the law.

What is claimed is:

1. A system for friction estimation, the system comprising:
a processor; and
a memory including instructions that, when executed by the processor, cause the processor to:
receive at least a rack position value associated with a rack of a steering system;
determine whether the rack position value is within a rack position range; and
in response to a determination that the rack position value is within the rack position range:
determine a hysteresis force correction value based on a steering input signal;
estimate a road friction value based on the hysteresis force correction value, and the rack position value; and
selectively control at least one aspect of the steering system based on the estimated road friction value.

2. The system of claim 1, wherein the instructions further cause the processor to determine a corrected gain parameter based on an input torque value and the estimated road friction value.

3. The system of claim 2, wherein the instructions further cause the processor to adjust the hysteresis force correction value based on the corrected gain parameter.

4. The system of claim 3, wherein the instructions further cause the processor to update the estimated road friction value based on the adjusted hysteresis force correction value.

5. The system of claim 1, wherein the instructions further cause the processor to:
receive a rack velocity value associated with the rack of the steering system; and
determine whether the rack velocity value is within a rack velocity range.

6. The system of claim 5, wherein the instructions further cause the processor to, in response to a determination that the rack velocity value is within the rack velocity range, estimate the road friction value further based on the rack velocity value.

7. The system of claim 1, wherein the instructions further cause the processor to:
receive a vehicle velocity value; and
determine whether the vehicle velocity value is within a vehicle velocity range.

8. The system of claim 7, wherein the instructions further cause the processor to, in response to a determination that the vehicle velocity value is within the vehicle velocity range, estimate the road friction value further based on the vehicle velocity value.

9. The system of claim 1, wherein the steering system includes a steer-by-wire steering system.

10. The system of claim 1, wherein the at least one aspect of the steering system includes a roadwheel actuator of the steering system.

11. A method for friction estimation, the method comprising:
receiving at least a rack position value associated with a rack of a steering system;
determining whether the rack position value is within a rack position range; and
in response to a determination that the rack position value is within the rack position range:
determining a hysteresis force correction value based on a steering input signal;
estimating a road friction value based on the hysteresis force correction value, and the rack position value; and
selectively controlling at least one aspect of the steering system based on the estimated road friction value.

12. The method of claim 11, further comprising determining a corrected gain parameter based on an input torque value and the estimated road friction value.

13. The method of claim 12, further comprising adjusting the hysteresis force correction value based on the corrected gain parameter.

14. The method of claim 13, further comprising updating the estimated road friction value based on the adjusted hysteresis force correction value.

15. The method of claim 11, further comprising:
receiving a rack velocity value associated with the rack of the steering system; and
determining whether the rack velocity value is within a rack velocity range.

16. The method of claim 15, further comprising, in response to a determination that the rack velocity value is within the rack velocity range, estimating the road friction value further based on the rack velocity value.

17. The method of claim 11, further comprising:
receiving a vehicle velocity value; and
determining whether the vehicle velocity value is within a vehicle velocity range.

18. The method of claim 17, further comprising, in response to a determination that the vehicle velocity value is within the vehicle velocity range, estimating the road friction value further based on the vehicle velocity value.

19. The method of claim 11, wherein the at least one aspect of the steering system includes a roadwheel actuator of the steering system.

20. An apparatus for friction estimation, the apparatus comprising:
a controller configured to:
receive at least a rack position value associated with a rack of a steering system;
receive a rack velocity value associated with the rack of the steering system;
receive a vehicle velocity value; and
in response to a determination that (i) the rack position value is within a rack position range, (ii) the rack velocity value is within a rack velocity range, and (iii) the vehicle velocity value is within a vehicle velocity range:
determine a hysteresis force correction value based on a steering input signal;
estimate a road friction value based on the hysteresis force correction value, the rack position value, the rack velocity value, and the vehicle velocity value; and
selectively control at least one aspect of the steering system based on the estimated road friction value.
